(19) United States
(12) Patent Application Publication
(10) Pub. No.: US 2013/0279756 A1
(43) Pub. Date: Oct. 24, 2013

(54) COMPUTER VISION BASED HAND IDENTIFICATION

(71) Applicants: Ovadya Menadeva, Modiin (IL); Eran Eilat, Givatayim (IL); Amir Kaplan, Hod-HaSharon (IL); Haim Perski, Hod-HaSharon (IL)

(72) Inventors: Ovadya Menadeva, Modiin (IL); Eran Eilat, Givatayim (IL); Amir Kaplan, Hod-HaSharon (IL); Haim Perski, Hod-HaSharon (IL)

(21) Appl. No.: 13/993,326

(22) PCT Filed: Dec. 15, 2011
(86) PCT No.: PCT/IL11/00944

§ 371 Date: Jun. 12, 2013

Related U.S. Application Data
(60) Provisional application No. 61/423,608, filed on Dec. 16, 2010.

(51) Int. Cl. G06K 9/00

(52) U.S. Cl. CPC G06K 9/00355
USPC 382/103

(57) ABSTRACT

There is provided a method for computer vision based hand identification, the method comprising: obtaining an image of an object; detecting in the image at least two different types of shape features of the object; obtaining information of each type of shape feature; combining the information of each type of shape feature to obtain combined information; and determining that the object is a hand based on the combined information.

### FIELD OF THE INVENTION

The present invention relates to the field of gesture based control of electronic devices.

Specifically, the invention relates to computer vision based hand gesture recognition.

### BACKGROUND OF THE INVENTION

The need for more convenient, intuitive and portable input devices increases, as computers and other electronic devices become more prevalent in our everyday life.

Recently, human gesturing, such as hand gesturing, has been suggested as a user interface input tool in which a hand gesture is detected by a camera and is translated into a specific command. Gesture recognition enables humans to interface with machines and interact naturally without any mechanical appliances. The development of alternative computer interfaces (forgoing the traditional keyboard and mouse), video games and remote controlling are only some of the fields that may implement human gesturing techniques.

Currently, gesture recognition requires robust computer vision methods and hardware. Recognition of a hand gesture usually requires identification of an object as a hand and tracking the identified hand to detect a posture or gesture that is being performed.

Known gesture recognizing systems detect a user hand by using color or shape detectors. However, such detectors are currently not reliable since they do not accurately identify a hand in all environments. Also tracking the hand through some environments is a challenge for these detectors.

Other known detectors may include contour detectors. These known detectors, which utilize edge detecting algorithms, are currently not suited for hand gesture recognition, among other reasons, because edges are difficult to detect during movement of an object.

Thus, there are still many unanswered challenges associated with the accuracy and usefulness of gesture recognition software.

### SUMMARY OF THE INVENTION

The present invention provides a method and system for accurate computer vision based hand identification.

According to one embodiment there is provided a method for computer vision based hand identification, the method comprising: obtaining an image of an object; detecting in the image at least two different types of shape features of an object; obtaining information of each type of shape feature; combining the informations of each type of shape features to obtain combined information; and determining that the object is a hand based on the combined information.

According to one embodiment there is provided a method for computer vision based hand identification, the method comprising: obtaining an image of an object; applying on the image at least two types of detectors, said detectors configured to detect shape features of an object, to obtain information from the two detectors; combining the information from the two detectors to obtain combined information; and determining that the object is a hand based on the combined information.

According to one embodiment shape features include a shape boundary feature (such as the contour of the object). According to one embodiment shape features include appearance features enclosed within the boundaries of the object.

According to one embodiment combining the information from the two type of features or detectors comprises assigning a weight to the information from each type of feature or detector.

According to one embodiment the method comprises applying a machine learning algorithm to obtain the contour information. According to some embodiments the method includes applying a distance function to obtain the contour information. According to some embodiments the weight assigned to the information from each detector is based on the reliability of each detector. The reliability of each detector may be specific to a frame environment.

In some embodiments the method includes combining the information from the two detectors and a value of a parameter which is unrelated to the detectors, to obtain combined information; and determining that the object is a hand based on the combined information.

According to some embodiments the parameter that is unrelated to the detectors comprises pattern of object movement or a number of frames in which an object is detected. The pattern of object movement may include movement of the object in a predefined pattern.

According to one embodiment the method may include presenting to the machine learning algorithm a hand and a non-hand object. The non-hand object may include a manipulated hand, e.g., a partial view of a hand.

According to one embodiment there is provided a method for computer vision based hand identification, which includes: obtaining images of an object; applying a contour detector to find contour features of the object; comparing the contour features of the object to a contour model of a hand to obtain a vector of comparison grades; applying a machine learning algorithm to obtain a vector of numerical weights; calculating a final grade from the vector of comparison grades and the vector of weights; and if the final grade is above a predetermined threshold identifying the object as a hand.

According to one embodiment the method includes subtracting two consecutive images of the object to obtain a motion image of the object; and applying the contour detector to find contour features in the motion image.

According to another embodiment the method includes applying on the image of the object an algorithm for edge detection to obtain an edge image; and applying the contour detector on the edge image.

According to one embodiment the method includes presenting to the machine learning algorithm at least one hand and at least one non-hand object, which may be a manipulated hand, such as a partial view of a hand.

According to one embodiment the method includes comparing the contour features of the object to the contour model of a hand comprises applying a distance function. The method may also include applying on the images another detector in addition to the contour detector to obtain information from two detectors; combining the information from the two detectors to obtain combined information; and determining that the object is a hand based on the combined information. According to one embodiment the other detector is a detector to detect appearance features enclosed within contours of the object.

According to one embodiment of the invention there is provided a system for computer vision based hand identification, the system comprising a detector to detect at least two different types of shape features of an object or at least two types of detectors, said detectors configured to detect shape features of an object from an image of the object, to obtain information of the different types of shape features or from the two detectors; and a processor to combine the informations to obtain combined information and to determine that the object is a hand based on the combined information.

The system may include an image sensor to obtain an image of the object, said image sensor in communication with the at least two types of detectors. Further, the system may include a processor to generate a user command based on image analysis of the object determined to be a hand. The user command may be accepted by a device such as a TV, DVD player, PC, mobile phone, camera, STB (Set Top Box) and a streamer.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a method for identifying an object as a hand using more than one detector, according to an embodiment of the invention;

FIG. 2 schematically illustrates a method for identifying an object as a hand by assigning a weight to the information obtained from each detector and combining the weighted informations, according to an embodiment of the invention;

FIG. 3 schematically illustrates a method for identifying an object as a hand by assigning a weight to the information obtained from each detector based on the reliability of the detector, according to an embodiment of the invention;

FIG. 4 schematically illustrates a method for identifying an object as a hand by assigning a weight to the information obtained from each detector, and by factoring in an additional weighted parameter which is unrelated to the detectors, according to an embodiment of the invention;

FIG. 5 schematically illustrates a method for identifying an object as a hand using a contour detector, according to an embodiment of the invention; and

FIG. 6 schematically illustrates a method for identifying an object as a hand using a contour detector, according to additional embodiments of the invention.

### DETAILED DESCRIPTION OF THE INVENTION

Methods according to embodiments of the invention may be implemented in a user-device interaction system which includes a device to be operated by a user and an image sensor which is in communication with a processor. The image sensor obtains image data (typically of the user) and sends it to the processor to perform image analysis and to generate user commands to the device based on the image analysis, thereby controlling the device based on computer vision.

According to embodiments of the invention the user commands are based on identification and tracking of the user's hand. The processor or image analyzing module of the system includes, according to embodiments of the invention, a detector capable of detecting at least two different types of object feature.

According to one embodiment the image analyzing module comprises at least two types of detectors. Information from the at least two types of detectors is combined and the combined information is used to identify the user's hand in the images obtained by the image sensor. Once a user's hand is identified it can be tracked such that hand gestures may be identified and translated into user operating and control commands.

Detecting more than one type of shape feature or the use of more than one type of detector, according to embodiments of the invention, raises the probability of correct identification of a hand, rendering the system more reliable and user friendly. In one example, where detecting two types of shape features or the use of two detectors may assist in correct identification of a moving object, shape boundary features are detected as well as appearance features. For example, a contour detector is used together with an appearance feature detector.

In this example, in a case where there is a large amount of light in the background (e.g. there is an open window in the background of the user) contour features become very clear but appearance features within the contour shape are less visible. On the other hand, in a background having elements that are similar to hand elements, contour features will be less visible than appearance features within the contour shape. Thus, combining a contour detector and an appearance feature detector raises the probability of correct identification of a hand in all situations that may occur while a user is operating a system.

Methods for computer vision based hand identification according to embodiments of the invention include obtaining an image (or images) of an object in a field of view by an image sensor, such as a standard 2D camera. The image sensor may be associated with a processor and a storage device for storing image data. The storage device may be integrated within the image sensor or may be external to the image sensor. According to some embodiments image data may be stored in the processor, for example in a cache memory. In some embodiments image data of the field of view is sent to the processor for analysis. A user command is generated by the processor, based on the image analysis, and is sent to a device, which may be any electronic device that can accept user commands, e.g., TV, DVD player, PC, mobile phone, camera, STB (Set Top Box), streamer, etc. According to one embodiment the device is an electronic device available with an integrated standard 2D camera. According to other embodiments a camera is an external accessory to the device. According to some embodiments more than one 2D camera is provided to enable obtaining 3D information. According to some embodiments the system includes a 3D camera.

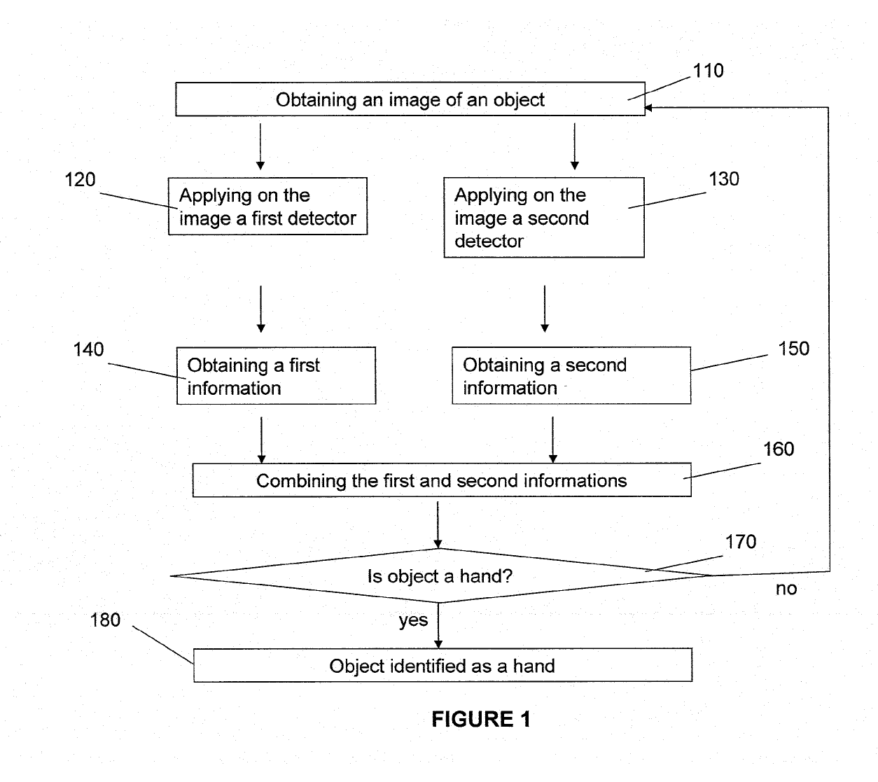

FIG. 1 schematically illustrates a method for computer vision based hand identification according to one embodiment of the invention. According to this embodiment the method includes obtaining an image of an object (110), applying on the image a first detector (120) to obtain a first type of information (140) and applying on the image a second detector (130) to obtain a second type of information (150). The first information and second information are then combined (160). The combined information is examined and a decision is made (170) either that the object is identified as a hand (180) or that it is not a hand and additional images are then processed.

The detectors applied according to some embodiments of the invention are detectors to detect object shape features. Object shape features typically include shape boundary features such as contours (e.g., the outer line of the object) and appearance features, such as features enclosed within the contours of the object. Object features may also include other physical properties of an object.

According to embodiments of the invention both different types of object features are detected in the same set of images and in some embodiments both detectors are applied on the same set of images rather than a first detector being applied on a set of images and the second detector being applied on the output of the first detector.

For example, a texture detector and edge detector may be used. If both specific texture and specific edges are detected in a set of images then an identification of a hand may be made.

One example of an edge detection method includes the Canny™ algorithm available in computer vision libraries such as Intel™ OpenCV. Texture detectors may use known algorithms such as texture detection algorithms provided by Matlab™.

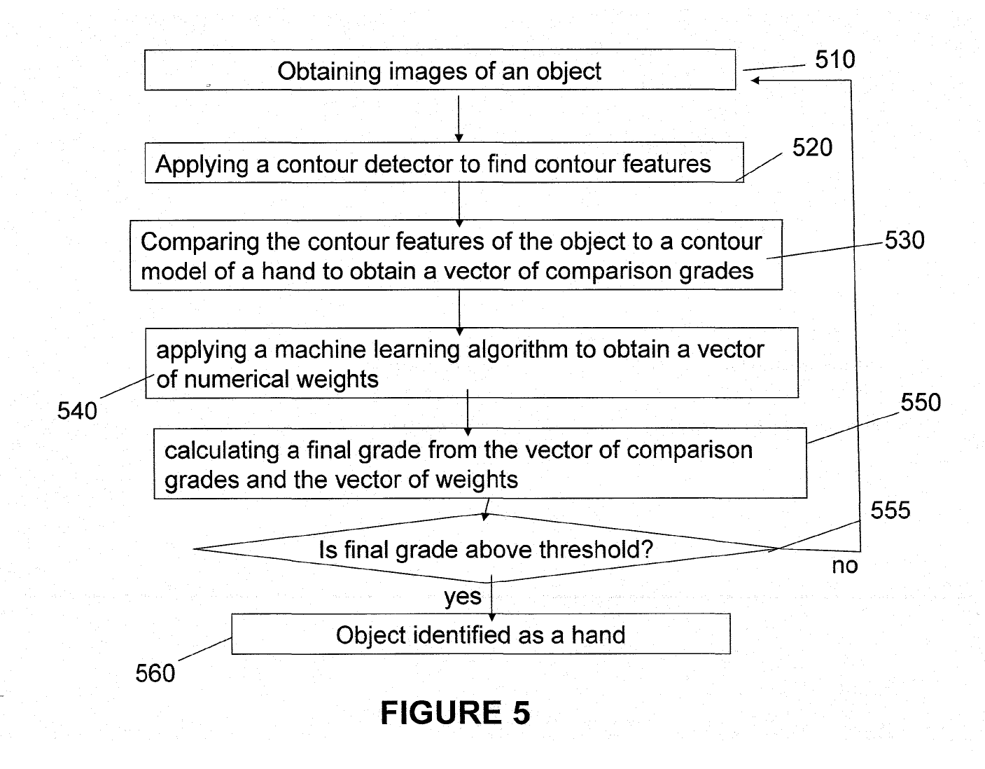

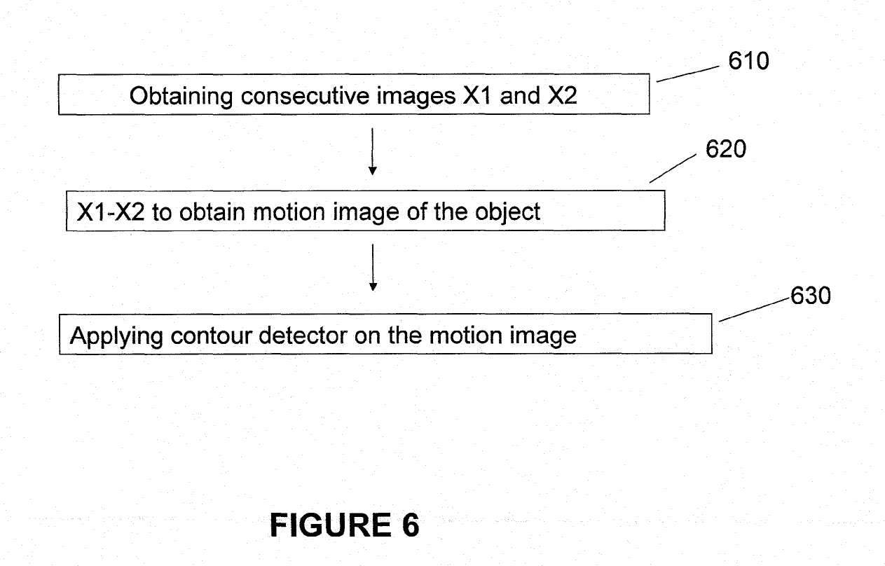

In another example, a detector using an algorithm for calculating Haar features is applied together with a contour detector. Contour detection may be based on edge detection, typically, of edges that meet some criteria, such as minimal length or certain direction (examples of possibly used contour detectors are described with reference to FIGS. 5 and 6 below). If both specific contours and a hand object (as identified by the Haar features) are detected in an image or in a specific set of images, an identification of a hand may be made.

Other combinations of types of features or detectors may be used.

In some embodiments more than two detectors may be used.

According to some embodiments two detectors to detect shape features of an object may be assisted by one or more additional detectors which do not detect shape features of objects. For example, a motion detector may be applied in addition contour detector and an appearance detector. In this example both motion and specific appearance and contour information must be detected in a specific set of images in order to decide that an object is a hand. According to some embodiments motion information showing movement of an object in a predetermined specific pattern together with shape feature information may be used to determine that the object is a hand.

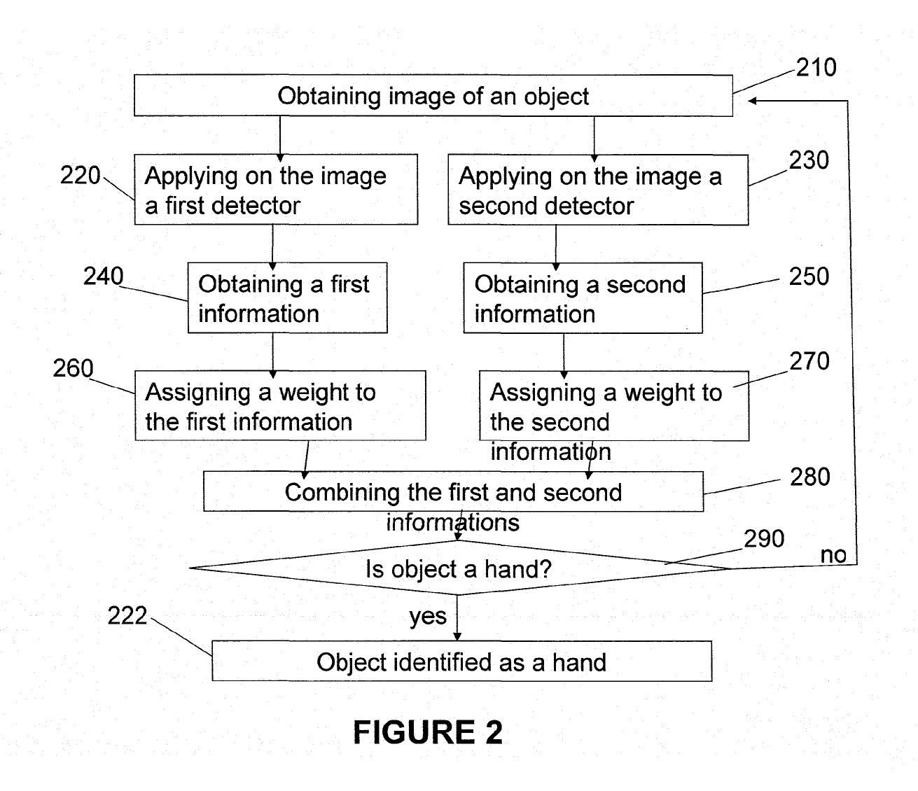

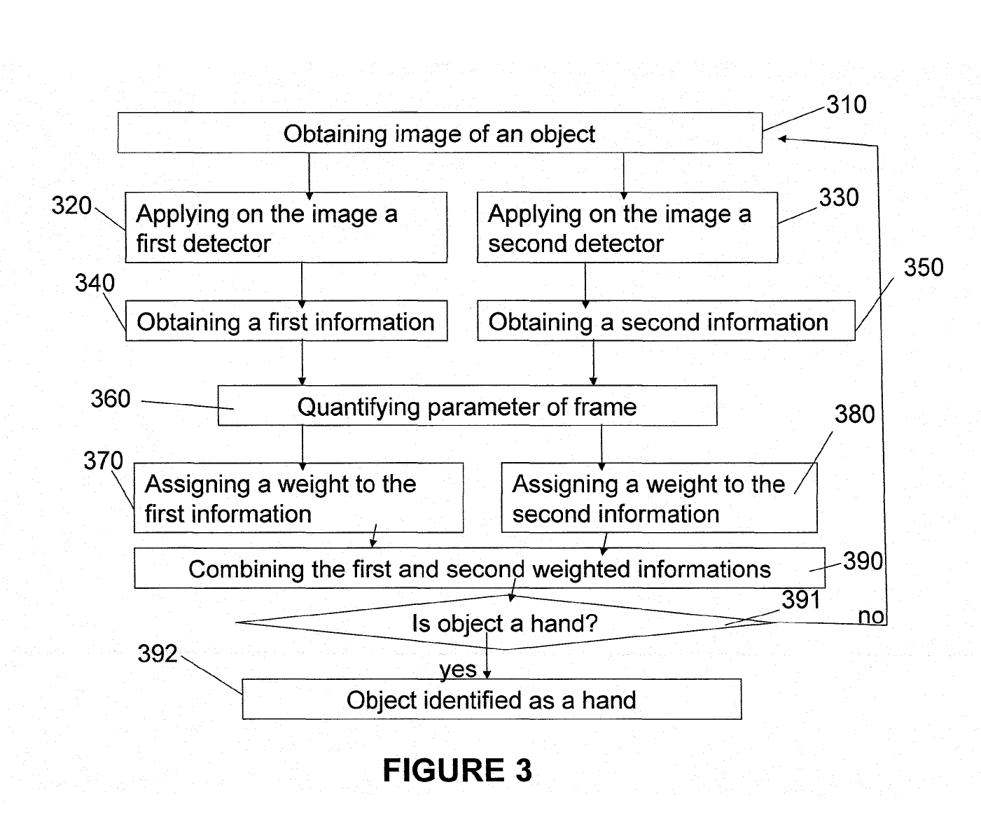

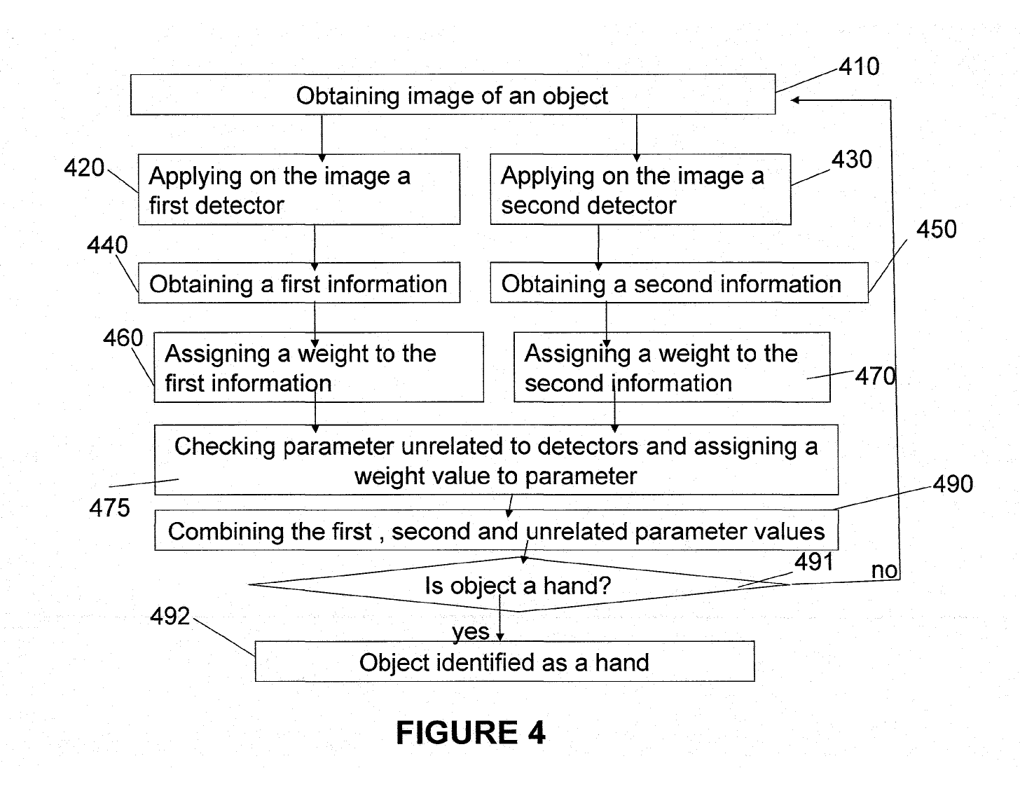

FIG. 2 schematically illustrates a method for identifying an object as a hand by assigning a weight to the information obtained from each type of feature detection or from each detector and combining the weighted informations, according to an embodiment of the invention. An image of an object is obtained (210). A first detector is applied on the image (220) to obtain a first type of information (240) and a second detector is applied on the image (230) to obtain a second type of information (250). The first type of information is assigned a first weight (260) and the second type of information is assigned a second weight (270). The weights may be assigned based on the reliability of each detector, for example, as detailed with reference to FIG. 3. According to another embodiment the identification of an object as a hand may be assisted by the weights assigned to each detector and by an additional parameter that is unrelated to either of the two detectors, for example, as detailed in FIG. 4.

The weighted informations are combined (280) to obtain combined information.

According to one embodiment a method for combining information may include the following calculation:

combined information=first information*first weight+second information*second weight.

Based on the combined information a decision is made (290) either that the object is identified as a hand (222) or that it is not a hand and additional images are then processed.

According to one embodiment, the reliability of a detector or of a shape feature may be specific to a frame environment.

Reference is now made to FIG. 3 which schematically illustrates a method for identifying an object as a hand by assigning a weight to the information obtained from each type of feature based on the reliability of that type of feature in a specific frame environment, according to an embodiment of the invention.

An image of an object is obtained (310); typically in one or more frames. A first type of feature is detected in the image (e.g., by applying a first type of detector on the image) (image may include a set of frames) (320) to obtain a first information (340) and a second type feature is detected (e.g., by applying a second type of detector (330) on the image) (e.g., on the same set of frames) to obtain a second information (350). Parameters of the frame or set of frames (e.g., motion, illumination) are quantified (360) and each type of feature or detector is assigned a reliability grade based on the frame parameters. For example, a texture detector (or texture features) may receive a low reliability grade in a high motion image since an object's texture may be blurred in such an image whereas a motion based contour detector (or contour features) may receive a high reliability grade for motion images. An appearance detector (or shape or appearance features) may receive a higher reliability grade than a contour detector (or contour feature) for a highly illuminated frame or set of frames, and so on.

The first information is assigned a weight (370) which is a function of the reliability grade of the first feature or detector for the current frame (or set of frames) and the second information is assigned a second weight (380), which is a function of the reliability grade of the second feature or detector for the current frame (or set of frames).

The weighted informations are combined (390). Based on the combined information a decision is made (391) either that the object is identified as a hand (392) or that it is not a hand and additional images are then processed.

According to some embodiments the process of identifying an object as a hand is assisted by additional parameters that are unrelated to the reliability of the detectors. FIG. 4 schematically illustrates a method, according to an embodiment of the invention, for identifying an object as a hand by assigning a weight to the information obtained from each feature or detector, and by factoring in an additional weighted parameter which is unrelated to the features or to the detectors.

In FIG. 4, an image of an object is obtained (410), typically in one or more frames. A first type of detector is applied on the image (420) (e.g., on a set of frames) to obtain a first information (440) and a second type of detector is applied on the image (e.g., on the same set of frames) (430) to obtain a second information (450). The first information is assigned a first weight (460) and the second information is assigned a second weight (470) either based on reliability of the detector per image (e.g., as described above) or based on other considerations. A parameter which is unrelated to the first or second detectors is checked and assigned a value (475), which constitutes this parameter's weight. The unrelated parameter may be checked typically using additional detectors and algorithms, such as a movement detector and tracking algorithms. For example, a parameter that may be checked may be the pattern of movement of an object. Thus, if, for example, an object is found to be moving in a predetermined pattern (such as a waving gesture), this parameter may be assigned a high weight value thus biasing the identification of the object as a hand. Another parameter that is unrelated to the detectors may be the number of frames in which an object is detected. Thus, if, for example, an object is detected and identified as a hand in only a small amount of frames in a set of frames, a low weight value may be assigned to the additional parameter whereas if the object is identified as a hand in many frames, the weight value of this parameter is raised.

The weighted informations of the detectors and of the additional unrelated parameter are combined (490). Based on the combined information a decision is made (491) either that the object is identified as a hand (492) or that it is not a hand and additional images are then processed.

Although the embodiments described above relate to the use of two detectors, the methods described are also applicable for at least two different types of object features even if they are detected by a different number of detectors or by other means.

FIG. 5 schematically illustrates a method for computer vision based hand detection which includes using a contour detector. The contour detector may be used as a sole detector or in combination with other detectors, for example as described above.

The method according to this embodiment includes the steps of obtaining images of an object (510); applying a contour detector to find contour features of the object (520); comparing the contour features of the object to a contour model of a hand to obtain a vector of comparison grades (530); applying a machine learning algorithm to obtain a vector of numerical weights (540); calculating a final grade from the vector of comparison grades and the vector of weights (550) and if the final grade is above a predetermined threshold (555) the object is identified as a hand (560), thus a hand is detected. If the final grade is below the predetermined threshold additional images are then processed.

As in the other embodiments described, once a user's hand is identified it can be tracked such that hand gestures may be identified and translated into user operating and control commands.

According to one embodiment both an object and a contour model of a hand can be represented as sets of features, each feature being a set of oriented edge pixels. A contour model of a hand may be created by obtaining features of model hands, which is a collection of multiple hands used to generate a model of a hand; randomly perturbing the features of the model hand; aligning the features and selecting the most differencing features using a machine learning techniques (e.g., as described below) out of the features of the model hand (e.g., selecting 100 most differencing features out of 1000 features) to generate a contour model of a hand. In addition, a weight and threshold may be calculated for each selected feature using the machine learning technique. The comparison of the object to the contour model (step 530) may be done, for example, by matching edge maps of the object and model (e.g., oriented chamfered matching). The matching may include applying a distance function. For example, a point on the contour of the object from within a region of interest may be compared to a centered model to obtain the distance between the two and an average distance may be calculated by averaging all the measured distances. If the distance is lower than the threshold calculated for that feature, the weight of that feature is added to the total rank of the matching. If the total rank is above a certain threshold, a hand object is detected (the object is identified as a hand).

According to one embodiment the machine learning process (step 540) includes receiving two inputs; one input is a training set which includes positive features and the other input is a training set which includes negative features. The learning process may result in a cascade of weak classifiers from which a strong classifier may be obtained. In addition a set of strong classifiers can be obtained from the learning process to compose a fast and robust final strong classifier.

According to one embodiment the positive features presented to the machine learning algorithm (used for example in step (540)) are hand features and the negative features are non-hand objects. Non hand objects may include any object, shape or pattern that is not a hand, as is typical in machine learning algorithms. However, according to one embodiment also a manipulated hand is presented to the learning algorithm as a non-hand object. A manipulated hand may include views of a hand but not a regular, full open hand. For example, a manipulated hand may include a first or a hand with only a few fingers folded. A manipulated hand may also include partial views of a hand (e.g., the base of a hand with only some of the fingers, a view of a longitudinal half of a hand, only the base of the hand, only the fingers, only some fingers and so on.). Since there are many objects in a user's environment having a contour that resembles a contour of a hand and a contour of partial views of a hand, teaching the system to treat these “partial hand objects” as “non-hand” objects may greatly contribute to the accuracy and reliability of the system.

Additionally, different hand postures or gestures may be detected by different detectors. Thus, each detector may be presented, as a positive feature, a hand in the specific posture of that detector, whereas hands in other postures are presented as negative features to that detector.

According to one embodiment, which is schematically illustrated in FIG. 6, a contour detector may be applied on a motion image to obtain motion contour information. According to this embodiment consecutive images (e.g., frames X₁ and X₂) of an object are obtained (610). The consecutive images are subtracted to obtain a motion image of the object (620); and a contour detector is applied on the motion image to find contour features (630).

According to other embodiments the contour detector may be applied on a single image. For example, an edge detector may be used (typically on a single frame) to obtain an edge image of an object and the contour detector may then be applied on the edge image to obtain contour features of the object.

The contour information may be combined with information from another detector (such as with an appearance detector) to identify the object as a hand, as described above.

1. A method for computer vision based hand identification, the method comprising: obtaining an image of an object;
detecting in the image at least two different types of shape features of the object;
obtaining information of each type of shape feature;
combining the information of each type of shape feature to obtain combined information; and
determining that the object is a hand based on the combined information.

2. The method according to claim 1 comprising:
applying on the image at least two types of detectors, said detectors configured to detect shape features of the object,
obtaining information from the two detectors;
combining the information from the two detectors to obtain combined information; and
determining that the object is a hand based on the combined information.

3. The method according to claim 1 wherein a shape feature comprises shape boundary features.

4. The method according to claim 3 wherein the shape boundary feature comprises contour information.

5. The method according to claim 1 wherein a shape feature comprises appearance features enclosed within boundaries of the object.

6. The method according to claim 1 wherein combining the information of each type of shape feature comprises assigning a weight to each information.

7. (canceled)

8. (canceled)

9. The method according to claim 6 wherein the weight assigned to each information is based on the reliability of each type of feature.

10. The method according to claim 9 wherein the reliability of each type of feature is specific to a frame environment.

11. The method according to claim 1 comprising combining the information of each type of feature and a value of a parameter which is unrelated to the features, to obtain combined information; and
determining that the object is a hand based on the combined information.

12. The method according to claim 11 wherein the parameter that is unrelated to the features comprises pattern of object movement or a number of frames in which an object is detected.

13. The method according to claim 12 wherein the pattern of object movement comprises movement of the object in a predefined pattern.

14. (canceled)

15. (canceled)

16. (canceled)

17. (canceled)

18. The method according to claim 1 comprising
obtaining a plurality of images of an object;
subtracting two consecutive images of the object to obtain a motion image of the object; and
applying a contour detector to find contour features in the motion image.

19. A system for computer vision based hand identification, the system comprising
a detector, said detector configured to detect at least two different types of shape features of an object from an image of the object, to obtain information of the two different types of shape features; and
a processor to combine the information of the two different types of shape features to obtain combined information and to determine that the object is a hand based on the combined information.

20. The system according to claim 19 comprising two different types of detectors.

21. The system according to claim 20 comprising an image sensor to obtain an image of the object, said image sensor in communication with the at least two types of detectors.

22. The system according to claim 19 comprising a processor to generate a user command based on image analysis of the object determined to be a hand.

23. The system according to claim 22 wherein the user command is to be accepted by a device, selected from the group consisting of a TV, DVD player, PC, mobile phone, camera, STB (Set Top Box) and a streamer.

24. A method for computer vision based control of a device, the method comprising: obtaining an image of an object;
identifying a hand in the image by combining information from at least two different types of shape features of an imaged object; and
controlling the device based on the identification of the hand.

25. The method of claim 18 comprising tracking the identified hand and controlling the device based on the tracking of the identified hand.

26. The method of claim 18 comprising identifying the hand by combining information from at least two different types of shape features of an imaged object and information regarding movement of the imaged object.
